(19) United States
(12) Patent Application Publication
(10) Pub. No.: US 2024/0193192 A1
(43) Pub. Date: Jun. 13, 2024

(54) System and Method for Matching and Visualizing Documents

(71) Applicant: LATENT KNOWLEDGE SOLUTIONS, INC., NEW YORK, NY (US)

(72) Inventors: James Reilly, IV, NEW YORK, NY (US); Chris Burke, NEW YORK, NY (US); John Cave, NEW YORK, NY (US)

(21) Appl. No.: 18/531,788

(22) Filed: Dec. 7, 2023

Related U.S. Application Data
(60) Provisional application No. 63/386,349, filed on Dec. 7, 2022.

(51) Int. Cl. G06F 16/33; G06F 16/34

(52) U.S. Cl. CPC G06F 16/3344; G06F 16/34

(57) ABSTRACT

A knowledge hub system and method is provided, based on personal knowledge and a plurality of documents, texts, or images generated by an individual or group saved in a user profile. A visual map is formed based on documents returned from keyword searches to connected databases, where visualizations and proximities are determined between known knowledge (such as search terms, a known article or articles, known content, and the like), and unknown knowledge, also known as latent knowledge (search results), based on a computerized analysis of similarities between search terms, documents, and key features of content in the knowledge hub. The resultant visualizations and maps may be used for various purposes including internet searching, organizing documents, project collaboration, thematic stratification of text- or image-based data, concept mapping, knowledge commercialization, and the like.

### FIELD OF THE INVENTION

This invention relates generally to techniques for matching documents to ideas existing in the human mind. More particularly, it relates to methods for finding similar documents in a database, such as any database of documents containing text, the world wide web or any unstructured text-based data source.

### BACKGROUND

Traditionally, pedagogy has been used as an application of psychosocial theories to further develop critical and creative thinking skills, and computer science has been used as a computational approach to structuring, searching and retrieving information. While these methods have, in the past, provided methods to develop new ideas, they are often cumbersome, limited in application, and not directly related to optimizing the materialization of new ideas that exists in the human mind, psyche, or as the collective memory of institutional knowledge.

Institutional software solutions to track knowledge seeking, internet search, and idea generation within a network of collaborators or employees does not exist. Retaining institutional knowledge or potential innovation is dependent on personal note taking and continued communication of future plans. Further, to manage a team responsible for the materialization of tacit knowledge into explicit knowledge and products is a challenge at any point in time. This problem expands as the complexity of the team, knowledge, market, and action plan increases. Thus, value dependent on future innovation is inherently lost as human conditions impact the mechanisms of knowledge generation and material production.

Due to the complexity of science and innovation, people have become reliant on computer technology to search databases for relevant documents to support new ideas. For example, internet searches today are used as part of custom data scraping and parsing systems including other databases. Currently, keywords and 2-D visualization methods, such as a ranked list, are used to search and collate information. Information retrieval systems are often evaluated by their accuracy in suggesting the best document, or string of text, to satisfy the search criteria. What is often overlooked, however, is the relatedness of results produces by databases curated with subject-matter specific sets of documents as a decision-making point of relevance for the searcher to evaluate when selecting a document to read further. Curated databases of documents may contain relevant documents to a project, or idea, but only when looked at from a specific vantage and not when considering the project overall. As a result, searches typically miss tangentially connected documents where the bridge sentence establishing relatedness is masked by other sentences which establish unrelatedness. In order to improve the selectivity of results, common techniques allow the user to constrain the scope of the search to a specified subset of the database, or to provide additional search terms. These techniques are most effective in cases where the database is homogenous and already classified into subsets, or in cases where the use is searching for well known and specific information. In other cases, however, these techniques are often not effective because each constrain introduced by the user increases the chances that the desired information will be inadvertently eliminated from the search results.

Search engines presently use various techniques that attempt to present more relevant documents. Typically, documents are ranked according to variations of a standard vector space model. These variates could include (a) how recently the document was updated, and/or (b) how close the search terms are to the beginning of the document, and/or (c) the importance of a document as determined by counting its number of citations or backlinks pages. Although this strategy provides search results that are better than with no ranking at all, the results still have relatively low quality. Moreover, when searching the world wide web to find documents which relate to a new idea existing only in the user's mind, this measure of relevancy is irrespective of unique context and pretense biased by the human's mind and prior experience leading to the creation of the new idea. For this reason, search results often contain documents biased by prior viewership and are unable to match on the basis of authentic document relatedness to the user's new idea and unique context. Search engines within curated database are designed to identify subject-matter specific documents, although no single system can search all databases and visualize all ideological and contextually specific overlaps, while also identifying bridges of relevance between documents which have no hypertext linking or connecting metadata.

The task of matching documents to unique ideas currently belongs exclusively to the human mind. Search engines provide metadata filters in addition to techniques established above to assist in identifying relevant web documents, or documents in a database. Most often, a single search bar is utilized in a search engine where the user can enter a keyword, a phrase, a question, or a search string consisting of text connected with Boolean operators or special keyboard symbols. Further, a ranked list of documents, where the top result is determined by a technique described herein, is most frequently used to present lists of documents to a user.

Establishing document relatedness to the human mind can be represented with a user creating a custom string of text, consisting of one or more sentences, which is used as the basis of a search query. This unique string of text can be supported with keywords, strings of keywords connected by Boolean operators, full abstracts of published work, full documents, or any text-based data uploaded from a user's computer. This compilation of user input makes up a singular ‘search model’, which is then used to create core concepts reflecting the project or idea. The search model is a unit with features that is used to match with documents returned from a search on the world wide web or connected database. Returned documents are broken into key features which allows feature-to-feature matching, as well as document-to-user-search-model matching.

### SUMMARY

Various aspects of the present invention provide systems and methods for ranking documents in a knowledge hub. One aspect provides an objective ranking based on the relationship between documents. Another aspect of the invention is directed to techniques for visualizing key features represented in a document and establishing relatedness between key features existing in documents returned from a variety of connected databases and the world wide web. Another aspect of the present invention is to provide a document relatedness method that is scalable and can be applied to large databases such as the world wide web. Another aspect of the present invention is to provide a project and idea record keeping method that is scalable and can be applied to represent projects and ideas existing within an individual, small group of people, institution, intellectual property legal structure, corporate legal structure, and purpose-driven application. Additional aspects of the invention will become apparent in view of the following description and associated figures.

One aspect of the present invention is directed to taking advantage of the linked structure of key features in a document to assign a rank to each feature in the user search model, where key feature rank is a measure of the importance of a concept in a document. Rather than determining relevance or a result only from the keyword or search query used to find results, or the intrinsic content of a document in a list of results, or from the anchor text of backlinks of a document, a method consistent with the invention determines importance from the conceptual relationship between key features of a search model and other documents or search models or key features identified with in the system.

Intuitively, a document should be important and relevant to a search query if it is highly cited by other documents and the search query is an accurate representation of the idea in a human mind. However, citations and importance as described above does not represent authentic relatedness between a document and the key features of a project or idea since importance a user places on key features in a search, search term, search model, and/or query may not align with importance as reflected by popularity of document citations and importance of citations found in the document. In fact, assuming so, and for this to be the primary method of searching documents and suggesting top results, makes it harder for a user to find supporting documents to their idea the more unique the idea, since a truly novel idea which has not been established in documents previously would have limited matches from the world wide web or subject-specific, curated databases. Thus, the importance of a document, and hence the relevancy rank assigned to it, should depend not just on number of citations, the importance of the citing documents, but on the relatedness of key features, concepts, found in the search model and documents returned from connected databases. This implies a user-specific definition of key feature rank within a search model as well as a probability distribution over sequences of words which is used to identify key features from documents in a list. The relevance of a document to a search model is a function of the key features defined in search models as compared to the key features found in documents returned from connected databases. The relatedness (also referred to herein as “similarity”) of documents may be calculated by an iterative procedure on content found in the invention described using search model querying building techniques, language models, principal component analysis, similarity measures between two or more sequences of numbers, or comparable signal processing techniques. These calculations allow documents to be visualized by a user using qualitative data assessment techniques, methods of which are described herein.

Because citations and key features are ways of representing the importance and context of a document, the most relevant document to a search model corresponds to a document which has the most relatedness between document key features and the key features established in the search model. Further, relatedness to other documents found in the list can also be quantified and visualized using these methods. Further, the relatedness of documents returned by each search query found in the search model to other documents returned and other supporting user information found in the search model can be established. Thus, a high rank in a list, or a proximal position to user search model data entry, utilizing a Cartesian coordinate system, in 3-D space, indicates that a document is considered relevant to the user search model. Most likely, these are the documents to which someone performing a search would like to direct their attention. Looked at another way, the relevance and importance of a document is directly related to the stochastic positioning of key features established by a user within a search model and this subjective relevance established in the search model which biases relatedness calculations which are used to organize documents returned from the search model query on the world wide web and/or connected databases. Because there is an infinite number of ideas which a user can create and an unknowable pattern of key features which determines the materialization of a project or idea, this method of determining document rank, identifying key features from documents and connecting them to key features of a search model, establishing relatedness between documents and ideas represented in a search model, and organizing this method within a computational system assigns higher ranks and more proximal coordinates to the most relevant documents and key features found in the invention and connected databases.

In one aspect of the invention, a computer implemented method is provided for calculating relatedness of key features in linked database documents. This method comprises the steps of: establishing the key features of a search-model-based query, obtaining a plurality of documents from a linked database, determining key features from at least some of the documents, at least some of the documents being both linked documents and linking documents, establishing key features as sequences of numbers, assigning at least one score to each key feature and/or document based on the scores of one or more linking documents and structure of the language model, assigning a coordinate, shape, and color to a plurality of documents and/or key features, processing relatedness of documents and key features according to their score or coordinate.

Additional aspects, applications, and advantages will become apparent in the view of the following description and associated figures.

### BRIEF DESCRIPTION OF THE DRAWINGS

FIG. 1 provides a flow chart of a knowledge model for use in searching documents.

FIG. 2 provides a flow chart of a system for determining document similarity.

FIG. 3 provides a flow chart diagram of an embodiment of the search building, visualization, and connected databases.

FIG. 4 provides a view of methods to search for documents using an embodiment of the presently disclosed system along with keyword and Boolean search strings.

FIG. 5 provides a view of a method of embedding custom sentences and paragraphs into a single or multiple keyword search using an embodiment of the presently disclosed system.

FIG. 6 provides a view of an embodiment of a visualization of search results of the present disclosure.

FIG. 7 provides a view of another embodiment of a visualization of search results of the present disclosure along with a display portion allowing review of the discovered documents.

FIG. 8 provides a view of an embodiment of the interface of the present system which identifies saved or discovered documents from a first search, and allows the addition for additional keywords or strings into the search content.

FIG. 9 provides a view of a use of the presently disclosed system to find similar articles based on discovered articles returned from a keyword search and analyzed via the mapping of search results.

FIG. 10 provides a view of another embodiment of the system used to edit and re-run previous searches.

FIG. 11 provides a view of an embodiment the presently disclosed system used to visualize embedded user documents along with new documents found via, for example, a keyword search.

FIG. 12 provides a view of an embodiment the presently disclosed system used to visualize saved documents from previous searches along with results from a new search.

FIG. 13 provides a view of an embodiment of use of the presently disclosed system wherein the visualization is adjusted to introduce a specific concept into the plot to intentionally stratify data in one direction or another.

FIG. 14 provides a view of the visualization of the present system with an additional set of recommended documents identified by the system as particularly pertinent.

FIG. 15 provides a view of an embodiment of the recommendation engine of an embodiment of the present system which identifies and integrates the suggested document(s). The system may organize by color or other marker documents that were sourced by the user, saved from other searches by the user, sourced by the system, and the like.

FIG. 16 provides a flow chart of an embodiment of an operation of the recommendation engine operation of the present disclosure.

### DETAILED DESCRIPTION

Artificial intelligence, data visualization, and knowledge graphs have been emerging because the complexity of data driving decisions and innovation in our modern world has eclipsed the capabilities of a human mind. These methods, along with pedagogy and computer science fundamentals may be used to optimize building connections between articles or literature, and knowledge discovery, idea generation, and material innovation, unstructured text-based data needs to be searched, analyzed, and contextualized in high-dimensional space, and present this information to humans in a plurality of visualizations and maps. For example, in a data searching context, simple keyword searching combined with a presentation of a list of results is inefficient and requires the user manually search through hundreds of documents to make a judgment as to relevancy and relatedness to the search at hand. This problem only compounds as more and more content is generated.

This present disclosure relates to research collaboration, knowledge management, and internet searching. More particularly, it relates to the tools and technology used to improve discovery of complex topics, connecting interdisciplinary subject matter and multimodal data, knowledge discovery from the internet or private data sources, project collaboration, and quantifying research ideation, material production, and need-to-capability matching across descriptions of skillsets or products. The system described herein is a computerized system operable to improve the computerized technology of search and research abilities and functions. The system is operable to be carried out on one or more computers which have a memory which stores all or part of the system instructions, processor or processor or processors operable to carry out the system operation, an input to allow user content, instruction, and operational input, and a display to present the search results, data visualizations, user interface, and the like.

During computerized searching, the art at present uses simplistic list views of article titles or product names which is limited and requires a tremendous amount of time and energy searching through many documents or products. The inefficient organization of search results causes a problem in the art of requiring a tremendous amount of time and effort to fully explore and understand connections between search results, relationships between content from search results or within a content body or “corpus,” connections and lack thereof in the state of an art, and the like. What is needed is an improvement in the computerized search technology which uses a knowledge hub to connect personal ideas or known knowledge with unknown documents, products, and knowledge to be searched for. For example, known knowledge may be pieces of content such as keyword search strings or general product descriptions, known individual content pieces like articles, combinations of keyword search strings and content pieces, and/or bodies of content including images, charts, audio, and video. Unknown knowledge may be pieces of content such as unknown documents, products, and knowledge, content pieces and bodies of content, among others to be searched for. The combination of known and unknown knowledge may be presented in a visual manner as a “visualization” to easily and efficiently identify similarities in the pieces of content.

The knowledge hub system disclosed herein uses computationally driven analysis techniques and data visualizations as a basis for search, literature visualization, comparing feature analysis of content, further data analysis, collaboration between multiple individuals on a single project, and multi-knowledge hub content analysis and subsequent computationally derived content synthesis and generation. The generation of and collaboration on ideas in a knowledge hub as described in present disclosure can be done quickly by any user, with almost no bias to level of intelligence or degree of expertise, can be done anywhere that a computer or internet source is found, in any language, in any combination of languages, and in conjunction with any type of text or multimodal data source or content such as an image, article, chart, piece of literature or subsection thereof, video or subsection thereof, or audio file.

In one embodiment, the system may operate by receiving inputs of known knowledge or “personal knowledge” to create one or more personal knowledge hubs for a particular users. This may involve the input of journal articles, web articles, and any other word and figure-based content, or content such as an audio file, video, or image that can be converted, in full or the key features of the content, into text. The personal knowledge may also be in the form of search terms. The personal knowledge content may be uploaded to a server of the system, or accessible to the system through the internet or other networked interface. The system is then programmed to perform visualization modalities to generate a visualization which shows similarities between the known knowledge, i.e. key features of inputted content unknown to the user, and the content therein. As discussed below, the visualization generated by the system may take various forms, but in many cases the visualization is shown as a plot which groups content and documents of the personal knowledge hub based on topic and/or keyword relationship and/or key feature of content. As such, system users can easily see the connections and relationships between the elements of the knowledge hub, which often reveals unknown or unrealized relationships in addition to the expected similarities of the documents.

In a further embodiment, the knowledge hub may be used as a basis for the system to perform further searching through connected databases and data sets for previously unknown documents and concepts relating to the existing personal knowledge hub. Searching may be based solely on the personal knowledge hub of existing content and keywords, and/or may be supplemented by additional keywords and documents outside of the existing personal knowledge hub corpus. For example, after an initial search is performed by the system and the search results are presented in the visualization, a user may select one or more content pieces which look interesting or related, and then perform another search including the selected content pieces for further refinement of the search and to identify unknown content which is related to the selected content pieces. Once done, the system may generate another visualization of the search results (which may include the known content as well in the visualization).

The system is operable to query databases and other data sets, and then perform an analysis of similarity of the identified documents or content. These documents or content may then be used to form a visualization of similarity to the content of the personal knowledge hub based on, for example, related concepts and keywords. Visualization may group similar documents together based on these concepts, keywords, as well as synonyms and other similarities. As noted below, visualization may vary but often is in the form of a multi-dimensional plot which groups articles and content together based on one or more similarities. In many cases, certain discovered content will have similarity to the knowledge hub based on a keyword or concept, while other discovered content will have similarity to the knowledge hub for a different reason such as different keyword or concept.

In still another embodiment, the personal knowledge hub may be searched against another user's knowledge hub or multiple knowledge hubs. This searching operates similarly to searching an outside database or content source, and generates a similar visualization as discussed herein. Such visualizations may be helpful in identifying similarities in research being done even if such similarities are not immediately apparent to individuals. This spurs collaboration, individual or group concept ideation, product prototyping, and identifies opportunities for growth of the concept or project which is the subject of a search model, knowledge hub, or collection of knowledge hubs linked together, or found elsewhere within the invention discuss hereto and therein.

Visualization modalities: The visualization of ideas in a knowledge hub is referred to as semantic contextualization, which involves extracting and generalizing concepts, entities, methods, names, or techniques, or transforming complete sentences into a data frame and applying algorithms or language models to match unique data frames of lemmatized or non-lemmatized, unstructured text, or match computationally, or user generated, themes abstracted from content including documents, images, videos, audio, or concepts found in the human mind. A semantic contextualization of ideas in a knowledge hub is a method for inspiring creativity in the human mind, by visually showing connections of key features of content to individuals.

The methodology of the present disclosure consists of four main parts: (1) uploading user ideas or documents or keywords into a user knowledge hub, which may also be called an Individual Search Model, (2) using known knowledge such as keywords and keyword search strings, which are user generated or computationally derived, to return documents from a connected data source, called the Search, (3) mapping together newly found documents and content to text, search queries, content and documents found in the Search Model, called Knowledge Visualization, (4) modification of the Search Model by saving and adding concepts, content or documents found in the Knowledge Visualization, called Iterating the Search Model, or modifying the Search Model with related concepts, new keywords, or new keyword search strings, which are represented in the Knowledge Visualization and/or provided by user input, referred to as computationally-derived Inspiration from Semantic Contextualization of ideas in a knowledge hub. Various embodiments of the present disclosure are depicted in the figures.

We can begin a Search Model based on personal ideas or ideas provided by a peer, mentor, supervisor, client or customer, and the like. The Search can be assisted by keywords identified via natural language algorithms or language models which survey and perform entity recognition and retrieval from keyword search strings, keywords related to user search strings not found in the knowledge hub, or content or documents uploaded into the Search Model. Knowledge Visualization can occur in a 1-D, 2-D, 3-D, or 4-D space, via multiple data analysis techniques. Iterating the Search Model can happen individually, within a private group of profiles, or within a public community of profiles accessible through a user interface such as a web portal. In a particular embodiment, the Visualization may be presented in an augmented reality or virtual reality view which may allow a user to view the data in an immersive manner. In augmented or virtual reality presentation embodiments, a user may be able to pan left, right, up and down, zoom in and out and select a pivot point within the space using a traditional flat screen interface and/or using a virtual reality headset. In still another embodiment, the system may allow a user to move through a large visualization as if the user is in a video game.

As Search Models are Iterated, the trajectory of their content can take any form and traverse into any subject matter. If Search Models loop back into subject matter already addressed, in an individual's profile, or represented by knowledge hubs found across an institution, community, or population, a network of Search concepts and keywords can be extended into subject matters not currently included into the knowledge hub network through known ontological structure, found elsewhere in the internet, or in institutional intellectual property, of new subject matters included in the Search Model, Search, Iteration of Search Model, and Semantic Contextualization of ideas in a knowledge hub. If the ontological trajectory of Search Model does not intersect with existing knowledge found in a Search Model, the system may be programmed may recommend similar content or documents found elsewhere in a similar or dissimilar Search Model network, found locally in a user's institution, or found only on the internet.

Semantic Contextualization of ideas in a knowledge hub in a 1-D space can take the form of keywords computationally identified from user content that are not included by the user in a Search Model. Semantic Contextualization of ideas in a knowledge hub in a 2-D space can take the form of word bubbles of words or concepts found in one or more documents included in a Search Model, a heat map showing overlap of concepts from two, or more, similar documents, or concepts found within a single document on a sentence-to-sentence, or paragraph-to-paragraph, basis, to show their similarities and differences in key features identified, computationally by the knowledge hub, or manually annotated by a user of the knowledge hub. Semantic Contextualization of ideas in a knowledge hub in a 3-D space can take the form of any number of ideas or documents represented at points plotted with cartesian coordinates where their position in space is determined by computing the similarity of data frames representing key features of the content or document, thus the most similar content or documents are close to each other, and unrelated content or documents are distant to one another. Semantic Contextualization of ideas in a knowledge hub in a 4-D space can take the form of any number of keywords included into a Search Model and Searched, returning new content or documents from connected data sources, which have not been searched by the user, and identifying new keywords, keyword search strings, content, or documents which are highly similar to ideas or documents currently found in a Search Model, as repeated and found over time from any number of connected databases.

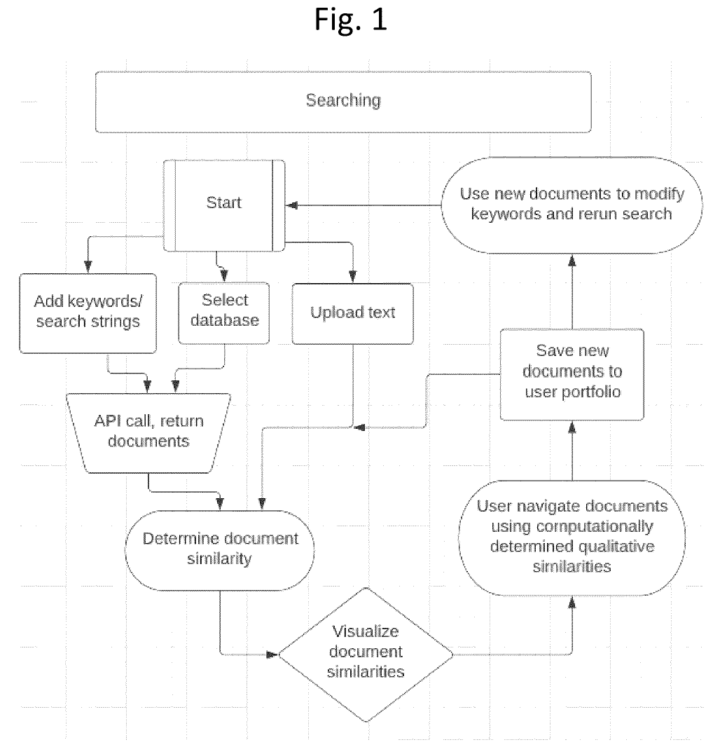

Turning to FIG. 1, a flow chart of an iterative search technique using the system disclosed herein is shown. Initially, a user adds keywords/search strings and/or known documents, selects a database or databases, and initiates a search. The system is operable to perform an API call of the selected database, and then returns identified documents. The system is then operable to determine document or content similarity, as discussed herein. Further, the system then uses the determined similarities to generate a Knowledge Visualization which compares the identified documents to each other and/or the selected keywords/search strings, and/or known documents using computationally determined qualitative similarities, such as key features of the content or qualitatively identified themes found inherent to the content. The user may then view and analyze the visualization, and further may navigate, via keyboard-based, mouse- or trackpad-based, or AR/VR-based user control techniques, the documents or content which seem, based on the visualization, of interest to the user. Any or all of the documents or pieces of content may then be saved to the user portfolio, group workspace, or community knowledge hub all of which may be stored on a computer memory. These saved documents may be incorporated in to one or more of the user's knowledge hubs, or kept separate for later review/processing, analysis, and the like. The search may then be iterated based on the new documents, modified keywords, and anything else learned during the prior searching process.

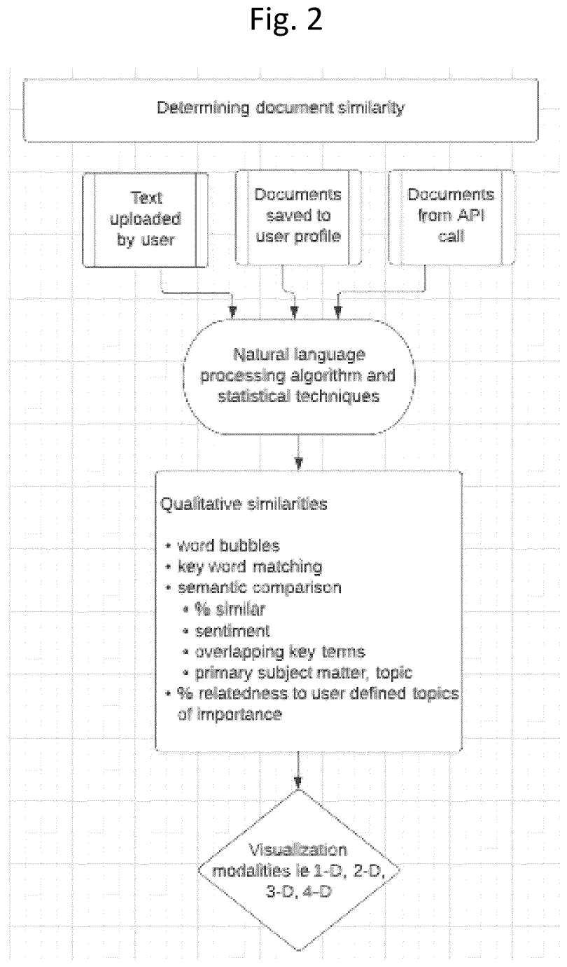

FIG. 2 provides a flowchart of an embodiment of determining document or content similarity for the visualization modalities of the present invention. A computerized system operates to perform the analysis. The system receives text or content uploaded by the user, documents or content saved to the user profile, for example as a knowledge hub, and/or documents or content from other outside databases or sources. A natural language processing algorithm or language model of the system is used, along with statistical analysis techniques to determine qualitative similarities of the knowledge hub content, and compute quantitative similarities of the content discovered in the Search related to the knowledge hub. Similarities may be based on word bubbles, keyword matching, semantic comparison such as percent similar or cosine similarity, sentiment, overlapping key terms, and primary subject matter and/or topics, as well as percentage relatedness to user-defined topics of importance or pieces of dissimilarly content manually mapped together as significantly related through a numerically-based rating system. The system then uses these determined qualitative similarities to create a visualization of the inputs, using modalities discussed herein, for example a multi-dimensional chart or charts.

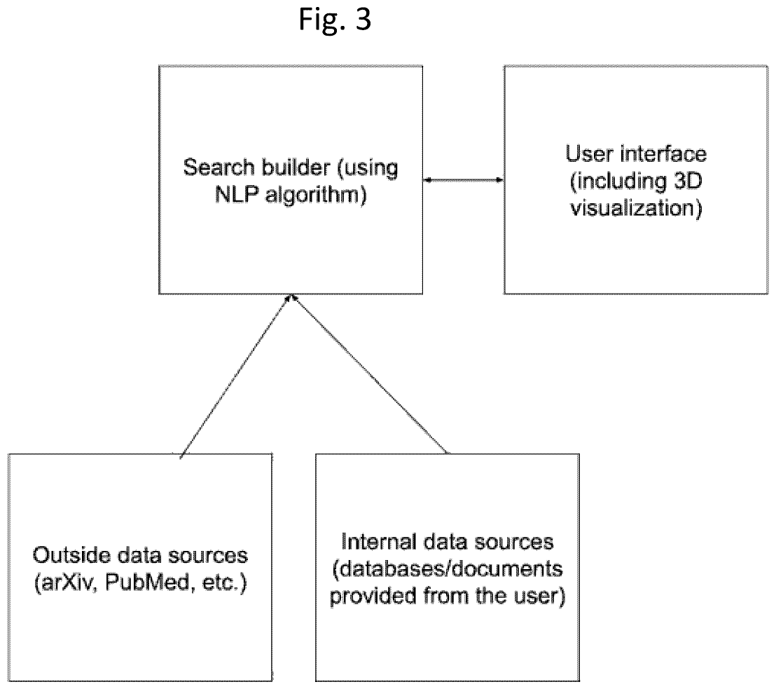

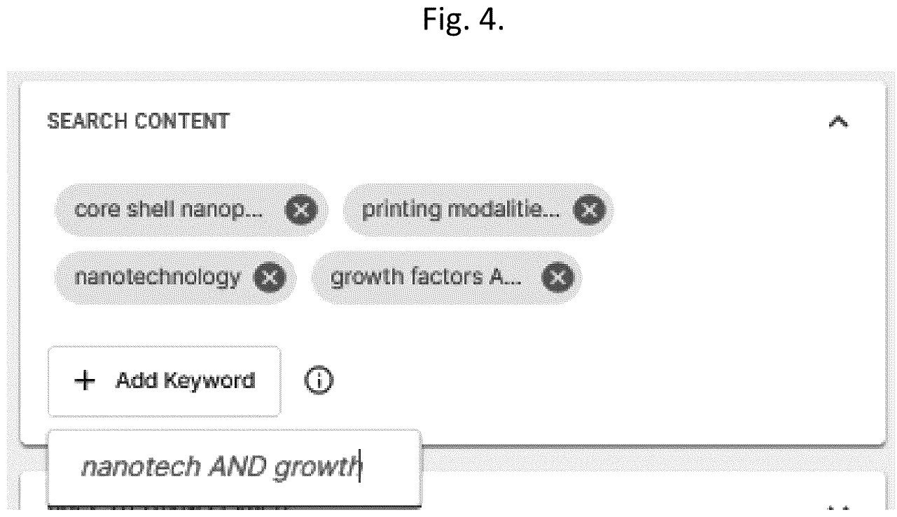

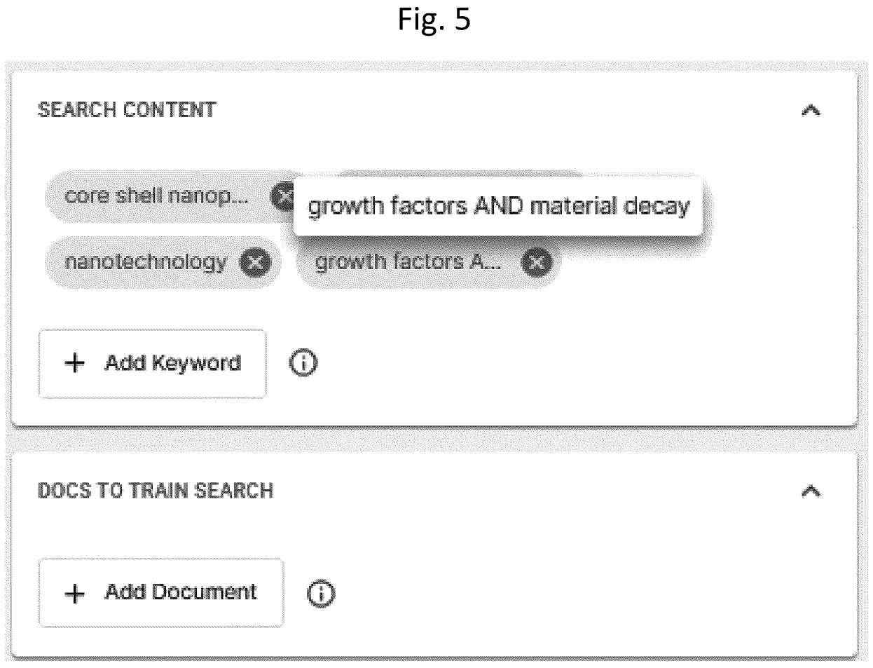

FIG. 3 provides a simplified diagram of a search builder of the present system. The search builder uses a natural language processing (“NLP”) algorithm and receives inputs. A user may also add additional keywords or phrases and/or documents to the search. The system then generates data visualization, as shown in later figures and discussed throughout, which represents the search results discovered. Outside data sources such as arXiv, PubMed, and the like provide content to the search system, as can internal data searches such as user-developed or provided databases and/or documents. FIG. 4 provides a view of an embodiment showing the search terms which can be added, removed, and/or modified for a search and/or re-search. Similarly, FIG. 5 shows the ability of the present system and user interface to embed custom sentences, paragraphs, and full documents into a single or multi keyword search.

Additional figures and screenshots included herein show the user interface and input approach for keywords and existing knowledge hub content. These further show the system searching outside content sources, and the generation of a 3D plot showing the similarities and groupings of related articles. As can be seen, some far-away articles on the plot are not relevant, while others are grouped very closely to the basis article, showing substantial similarities. The plot also shows that some keywords are more closely related than others, and that only a few articles have similarity on all keywords. This can be used to identify existing substantial research, as well as the fact that there is limited research in the field of the specific grouping of keywords and other knowledge hub content. The visualizations shown demonstrate how the system allows for very rapid identification of related and unrelated content, as well as how and why the relationships or lack thereof exist. This provides a marked improvement over the prior art as well as an improvement in the functioning of current computer technology.

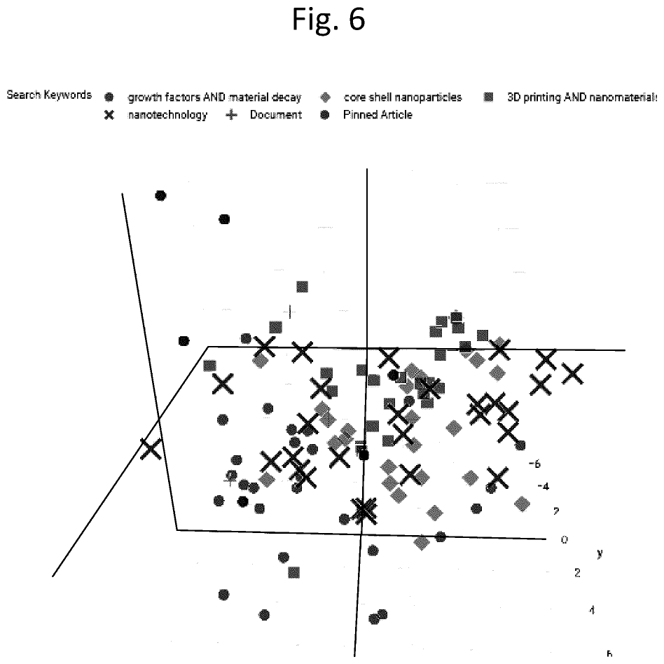

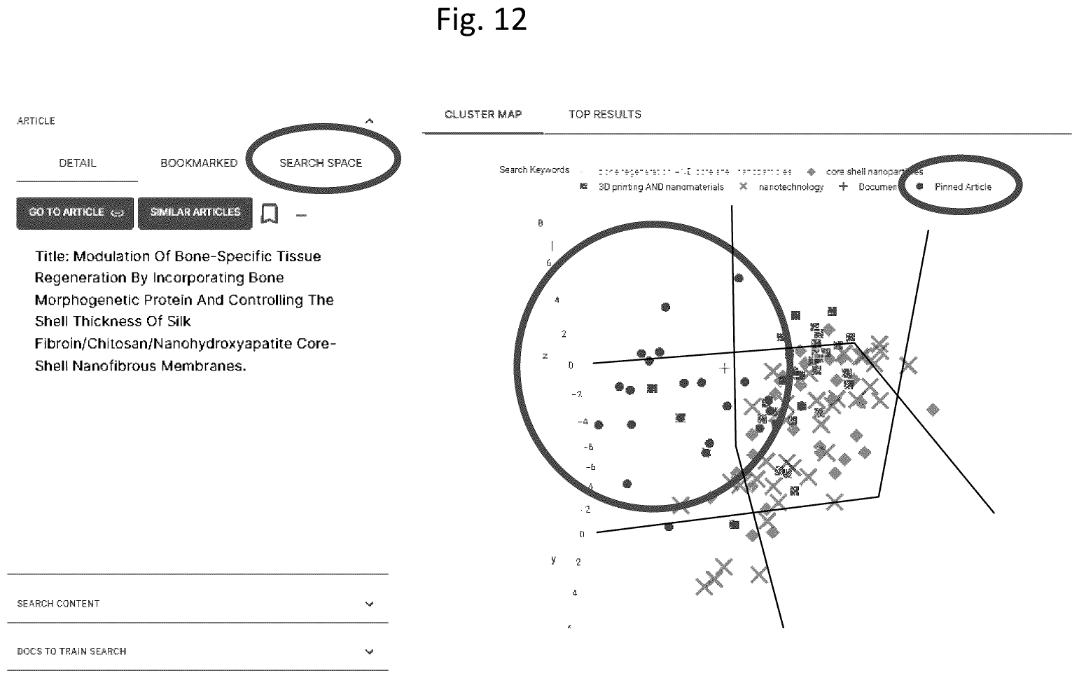

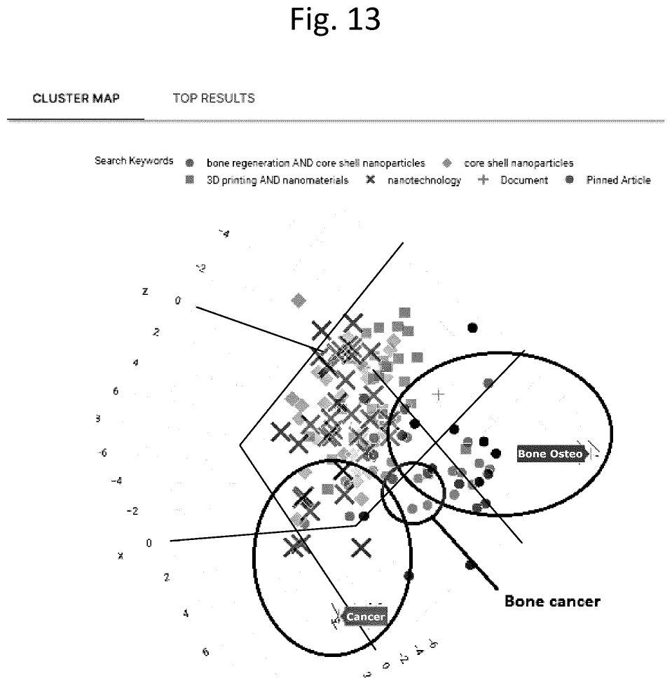

As can be seen in the figures demonstrating examples of visualization on a 3D plot (FIGS. 6, 7, 11, 12, 13, 14), documents closest to the centroid (coordinates 0,0,0) identify documents which are most generally related to all of the key terms being analyzed in the visualization. Points further on the fringe of the charts (having coordinates of greater magnitude) refer to documents that are less similar in all terms, though may have similarities with other documents represented by points that are close to each other. Points that are close to a zero coordinate on one axis but not others refer to documents that are closely aligned with one search term but not the others. This can be seen, for example, in the visualizations in FIGS. 12 and 13 which include coordinates on the chart. It should be understood that in many embodiments coordinates are not required in a visualization because the centroid of the chart can be displayed in a number of ways and fringe points may be easily identified by their distance from the centroid regardless of coordinates.

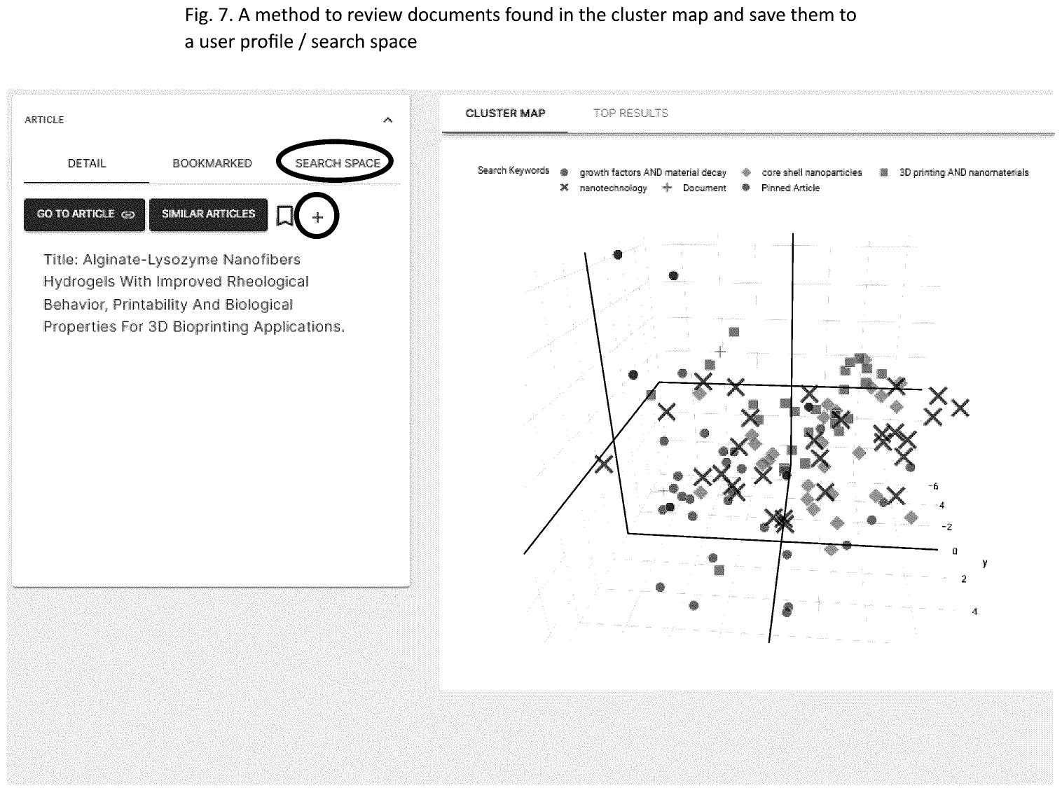

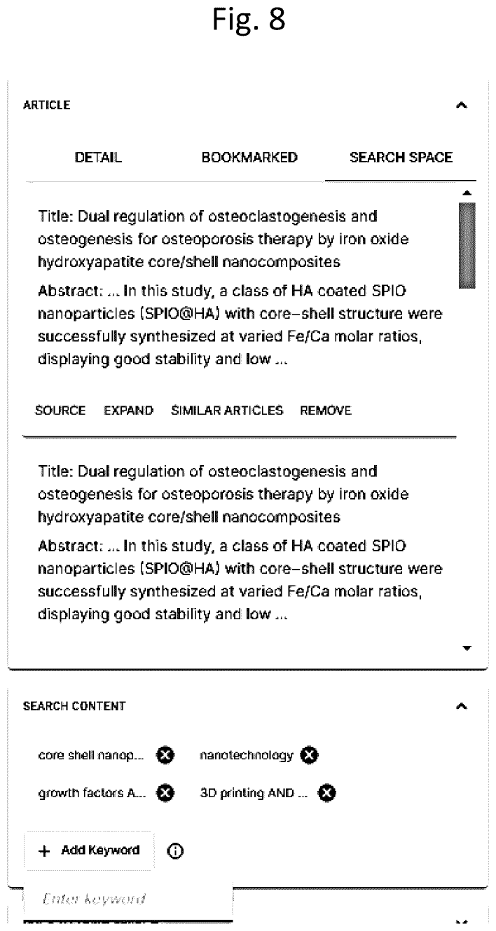

The visualization of FIG. 6 provides a 3-D plot showing four different search strings, as well as a user-selected document (shown as the plus sign marker) and pinned articles selected by the user from a previous search (shown as a dark circle). Manipulation of the visualization, which can be rotated and viewed from different angles using the user interface, allows the user to identify what search terms generate close or relatively distant relatedness of documents. In a particular embodiment, a user may use a gesture such as a click, tap, or movement of a cursor over a marker which will display additional information about the particular search result such as title, etc. The view of FIG. 6 along with other visualization views show documents (links etc.) in a visualization from multiple keyword searches in a single 3-D space where documents' x, y, z coordinates are calculated using artificial intelligence assessing similarity of natural text as found in the document. Semantically similar documents are clustered closely together, while dissimilar documents are distally positioned. FIG. 7 shows a view having the visualization in one pane, and a listing of article details in another separate pane. In a particular embodiment, the article (web-page) contents itself may be displayed in the left pane without navigating away from the search results—which is a known challenge in the searching arts causing users to lose their place and flow of searching as well as train of thought. FIG. 8 provides a detail view of a pane allowing users to gather detail of the search results, save certain search results, save search strings and strategies, and add new keywords/phrases to a search content. Natural language processing model or models may be used to identify the similarity between two documents or portions of documents. The system may then further identify the key features, which may be identified by the natural language processing model(s) or guided based on the input search terms. Coordinates may then be assigned related to the key features and the similarity of the documents.

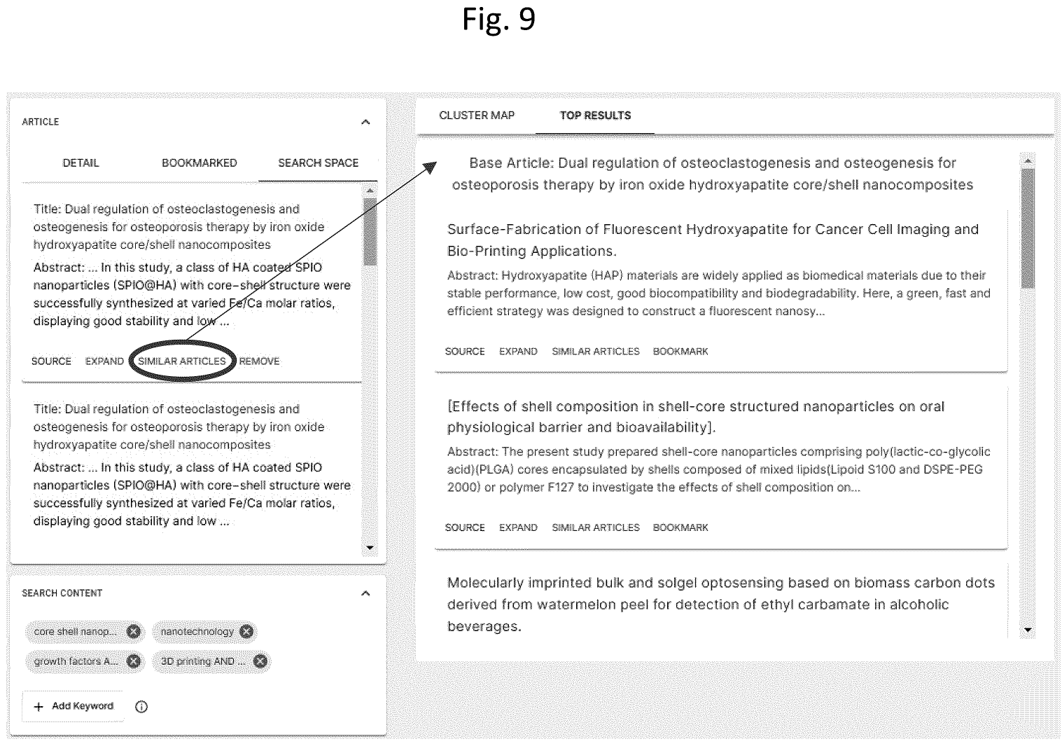

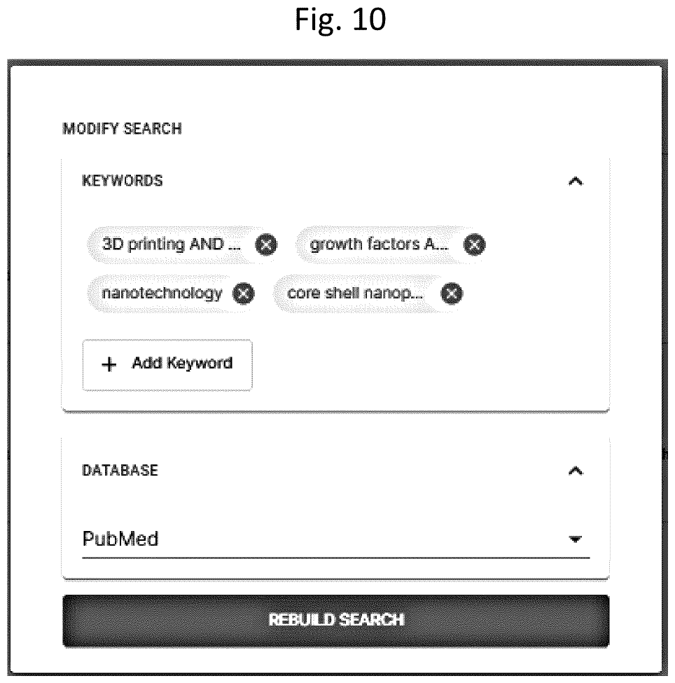

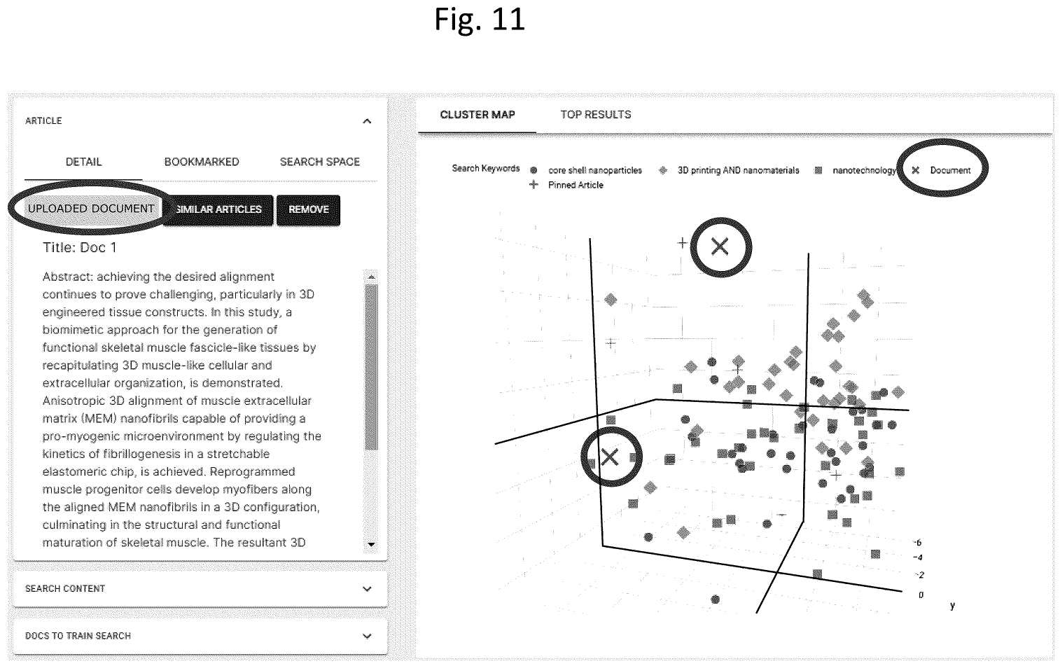

FIG. 9 shows an embodiment of the present system allowing for a user to identify similar articles in a list view to an identified search result document. Again, this view may be presented in a separate pane, allowing a user to stay in the same user interface without navigating away from the present system in a browser. FIG. 10 provides a detail view showing an embodiment of the user interface as a method to edit and rerun previous searches for additional visualization. FIG. 11 provides a view of the system having generated a visualization that shows not only search results based on a keyword search, but also a relative similarity to uploaded or embedded user document(s). FIG. 12 provides a view of the visualization having a pinned article which allows visualizing saved documents from previous searches amongst new search results. The pinned articles in this view can be seen as relatively “far away” or distant from the bulk of the other search results documents. This shows a potential lack of overlap relating to keyword searching and pinned article(s).

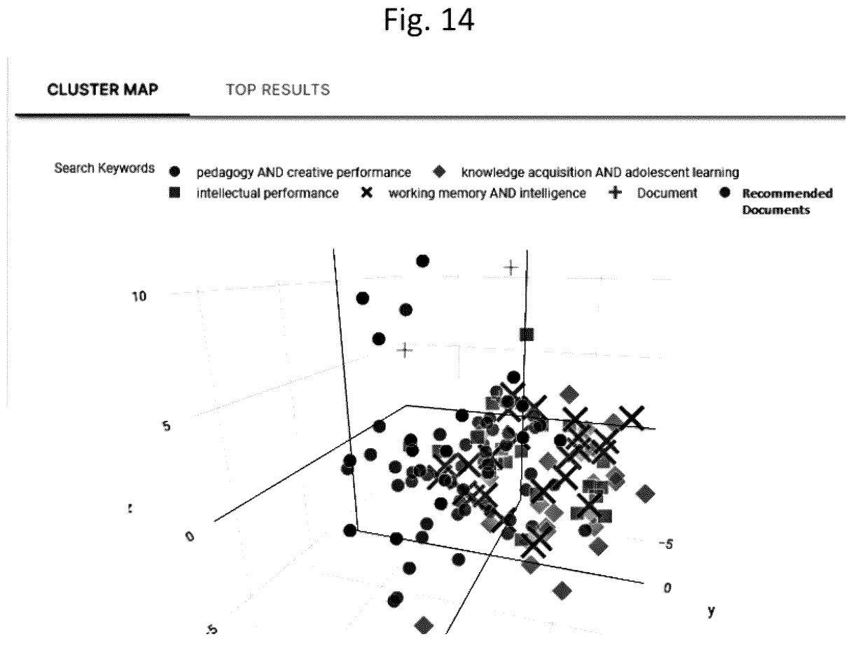

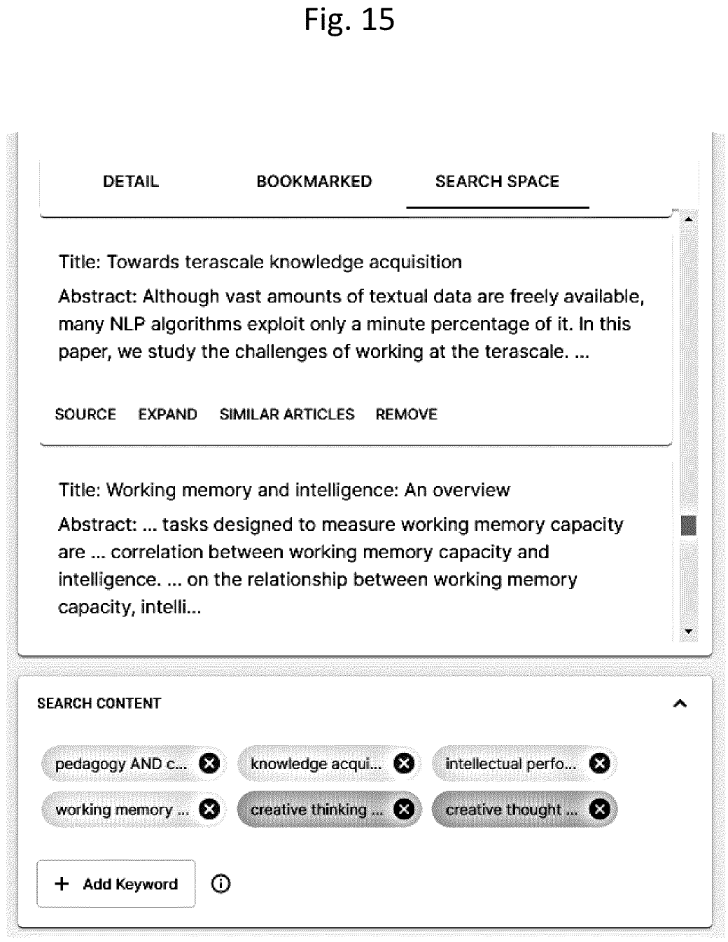

FIG. 13 shows a visualization of the system having a specific concept or article introduced which stratifies data in one direction or another. In this view, asset of concepts relating to bone cancer are identified, including “cancer” generally, and “Bone Osteo” particularly, with the overlapping area highlighting the bone cancer references that may be most pertinent from a similarity perspective. FIG. 14 shows an embodiment having the visualization system also provide recommended documents based on identified similarity to search strings, and the other documents revealed by the search. FIG. 15 provides a detail view of a pane showing the recommendation engine's suggestions, which can include color coded identification of different items which relate to documents sourced from articles saved to the user's profile, stored in the search space, identified in search results, recommendations, and the like.

As noted herein, the pieces of content used for the knowledge hub may be any content, including but not limited to written content and content which may be converted into written language. This may have many applications across various fields. For example, a knowledge hub may include content pieces from social media platforms and/or news platforms such as user postings and user comments and other engagement (views, likes, and so forth). Similarly, product descriptions and reviews may be part of a knowledge hub, such as product information and reviews from Amazon® and other online e-commerce services. Such data may be used as trend data, market data, opinion data, and the like, and may be used in advertising research, among other applications. In further embodiments, the system may be used for legal research purposes, as it is able to very quickly analyze large quantities of data such as case law and legal treatises to identify similarities between documents. This may be particularly helpful during legal research to both identify cases which have similar content to a knowledge hub base and/or one or more known cases, as well as to identify analogous lines of reasoning to a proposed or existing legal strategy.

In still further embodiments, the system may be used for educational and/or academic research, which may be guided in a teacher-student relationship, or lead researcher-assistant researcher relationships. Depending on embodiment, the teacher or lead researcher may be able to assign tasks and sub-tasks of data analysis, highlighting and note-taking of discovered content pieces, analysis of one or more Visualizations generated by the system, and the like. In yet another embodiment, the present system may be used for human resources applications, for example searching for resumes and comparing them to existing job postings. The system may identify certain terms for use as variables and may identify similarities between job posting and resume to identify potential good matches for a job candidate. This may be particularly advantageous due to the well-known challenges in finding good job candidates and the difficulties in human reading of resumes. The system is operable to provide a visual representation of the objective closeness of a plurality of resumes to a particular job description.

The system contemplated herein may further have a recommendation engine which may aid in research and in discovery of new content based on search terms and/or search results. In further embodiments, the system may be operable to incorporate content suggested by the recommendation engine into a visualization from an existing search result Visualization. As seen in the figures, the recommended content may be presented in a visually different manner, such as by using a different shape and/or color for recommendation engine-identified content, thereby allowing the user to easily identify content provided by the recommendation engine as well as its relevance relative to the search results generated by the system.

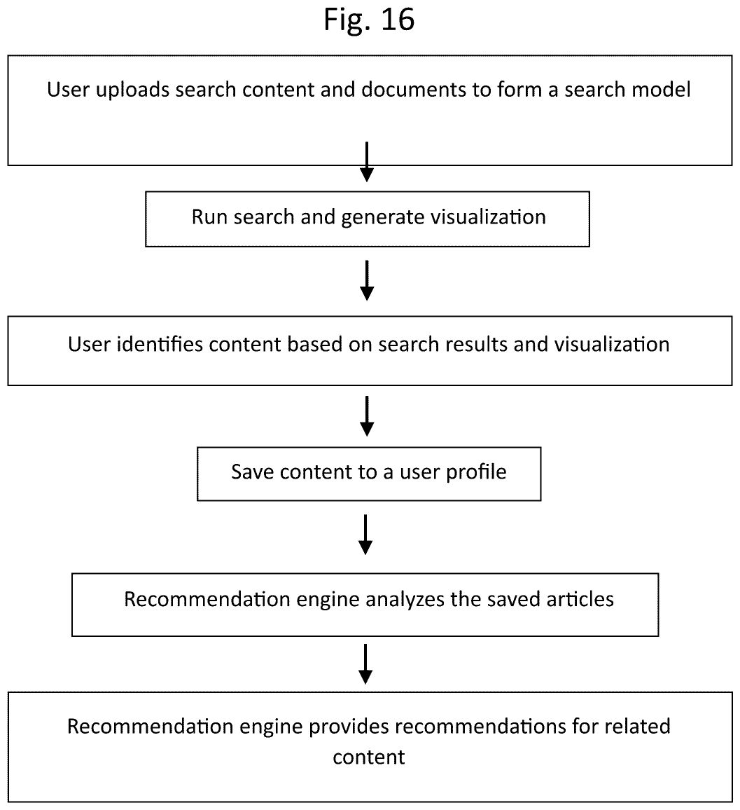

An embodiment of operation of the recommendation engine is shown in FIG. 16. In this embodiment, initially a user uploads search content and documents to the system to form a search model. The system then runs a search and generates a visualization as discussed throughout this disclosure. A user may then identify content based on the search results and visualization that seems particularly useful save this content to the user's profile. The recommendation engine may then analyze these saved articles and may be programmed to identify additional articles for related content based on an analyzed content of the saved content.

In one embodiment, the recommendation engine may use natural language processing, but of course other methodologies may be used without straying from the scope of this disclosure. In a particular embodiment, the recommendation engine may operate as follows. Initially, a user may upload search content and documents to form a search model. The user may then identify content such as articles, based on search results and visualization, or through other means, and save this content to a user profile to read and/or refer back at a later time. At this point, the recommendation engine may analyze the saved articles and provide recommendations for related content. This may be in the form of search terms and/or identified searched content based on the analysis. In one embodiment, the recommendation may be operable to perform name and entity recognition on the saved content to find similar but new keywords and content for addition to the search model which is related to the initial search content. The user may choose to include or exclude the recommendation engine suggestions.

Further, the invention may be operable to recognize new names, entities, keywords, and the like as related to the saved articles using processes such as document vectorization and semantic comparison by a machine learning language transformer model. For example, the system may use a language model such as BERT, GPT-3, and the like. Once done, the system may be operable to build new search models based on the newly recognized terms which are suggested by the recommendation engine. Such new search models may be new searches based only on the new terms, or by adding new terms as standalone keywords along with the existing search model and saved documents or adjoined to the initial search string by an “AND” term. Further still, the system may generate a visualization such as a cluster map shown in the figures, where the newly recommended documents are presented as a new symbol to identify them as from the recommendation engine. The system may further present the recommended documents relative to the known saved documents for a side-by-side showing as to how they are similar and different such as by showing terms with similar or dissimilar root words, terms denoting things of similar or dissimilar taxonomical classification, features such as similar experimental conditions but performed on dissimilar populations, and the like.

In a further embodiment, the present system may also provide a knowledge hub workspace. The knowledge hub workspace may be formed by a user to “lock” or otherwise embed one or more foundational documents or pieces of content into the specific knowledge hub to create a templated “workspace.” The workspace may have varied sharing settings allowing an initial user to optionally share access to the workspace with one or more users, or may make it accessible to the public. In further embodiments, the knowledge hub workspace may allow users to select and identify certain sections and content within a piece of content such as a journal article or legal case. This identification can include highlighting which provides a visual identification of pertinent sections. The identification can also include a note taking input section which allows users to add notes and comments relating to the piece of content. These notes and comments are saved relating to the knowledge hub workspace on the server and are accessible via user interface to all those having access to the knowledge hub workspace. This implementation allows settings and status, and other information to be saved on a server or other remote storage which is accessible through a user interface of a user computerized device. This may be particularly useful for research on a particular topic which has a known state of the art defined or summarized by certain content pieces such as a certain number of seminal articles, legal cases, research sources, or the like. This may be helpful to solve the known problem, particularly in the computerized research field, of “going down a rabbit hole” wherein research begins at a known base, but then goes on a tangent as more and more distinct articles are presented. Again, typical online content presentation is in a list form with a link to full article and a short summary. This lends itself to following one item of interest, which leads to another and another causing the information to become less related and “off track.” Such embodiments which allow pinning or otherwise locking particular articles within the search field serves to anchor the visual presentation of the search results to ensure that the newly found research or discovered similarities stay on track.

In still further embodiments, the system, through the user interface, is operable to automatically generate a citation, such as an MLA citation upon a selection of certain text and a highlighting or other marking of the text within the content piece being viewed. Such a citation may be automatically stored in the notepad and/or may be presented via the user interface to the user.

In a further embodiment, public access may be different from private administrator access. In one public access embodiment, collaboration contributions maybe deidentified which may hide identifiable data which is part of the search model or workspace, but may allow access to the underlying content of the knowledge hub at issue. The system may be operable to record the username or other identifying information of all contributions to the knowledge hub, notes, identified content pieces, comments, and other similar inputs. A user may access the knowledge hub using a login and the system may record that the logged in user contributes a particular element to the knowledge hub and process in generation, research, access, review, and the like. In certain cases, private workspaces may have a publication option to make all or some content publicly available. In addition, a paid membership model may allow user access to private workspaces, which may include more interaction with visualizations and analysis than a public access, among accessibility other content and visualization methodologies.

In a further embodiment, the user interface may provide an analysis box which may provide visualizations, such as those described above, on a limited number of content pieces within the knowledge hub. This may allow for additional and further analysis of content within the knowledge hub as to how it relates to either the whole or other individual content pieces. The “analysis box” portion of the user interface may allow users to select or “pin” content pieces in the knowledge hub, newly discovered search content pieces, as well as portions of content pieces such as highlighted sections of the content and notes relating to the content. The system may then be operable to generate a visualization, such as a 3D visualization of the relationships between the “pinned” content. The visualization may be further tunable by selecting different points of relevance based on generated relevance terms presented by the computerized system based on analysis of the documents and identification of relevant extracted topics or points within the document (content piece). Upon selection of particular points of relevance, the system may generate a new visualization based on the selected relevancies. In one embodiment, selected relevant points may be used as axes on the visualization, though this is not necessarily required.

In a further user-interface embodiment, the system may be provided as a computer application, which may be in the form of a widget, browser plug-in, software add-in, desktop or mobile app, and the like which provides access to the system and features. In other embodiments, the system may be purely web-based accessible through a web browser. Application embodiments may be advantageous in that they allow a user to further browse documents and content within the application interface, and may integrate a browser or content viewer into the application's user interface. By maintaining a portion of the application user interface on the screen, the user may easily and efficiently return to the primary views of the system such as knowledge hub, visualization, and the like. In a browser-based embodiment, if a user accesses a content piece such as a journal article, the user may end up navigating away from the system's webpage, making it difficult to return and resulting in lost data or a lost user. In a particular browser-based embodiment, the system may be operable to allow the user to access the external content piece by integrating the content into at least a portion of the user interface of the system, so that the user does not need to fully navigate away from the system web user interface. The system may also provide shortcuts to allow “one-click” access to snap to the system or document, as well as easy access to highlighting features, note taking features, search visualization and analysis box such that upon the clicking of an icon or other area, the desired view is presented on the user interface. Accordingly, the system is operable to provide various solutions for the known problem in the computer technology field of losing one's place or otherwise navigating away in a web embodiment.

While several variations of the present invention have been illustrated by way of example in preferred or particular embodiments, it is apparent that further embodiments could be developed within the spirit and scope of the present invention, or the inventive concept thereof. However, it is to be expressly understood that such modifications and adaptations are within the spirit and scope of the present invention, and are inclusive, but not limited to the following appended claims as set forth.

1. A computerized system for generating a visualization of search results comprising:
a computer having at least one processor, wherein the at least one processor is operable to:
receive one or more search terms and an indication of one or more data corpus to search;
perform a search through the one or more data corpus based on the received one or more search terms to generate search results;
analyze the search results using natural language processing to identify the relatedness of the search results to each other;
assign a plurality of coordinates to each of the search results based on the identified relatedness, wherein coordinates of greater magnitude have less relatedness and coordinates of magnitude closer to zero have more relatedness; and
presenting a chart showing the search results plotted based on the assigned plurality of coordinates for each of the search results.

2. The computerized system of claim 1 wherein the presenting of the chart allows the chart to be movable to view the plotted results from different views.

3. The computerized system of claim 1 wherein a selected one of the search results can be selected by a received user input, and wherein additional information about the selected one of the search results is presented on a pane on a display adjacent to the presented chart.

4. The computerized system of claim 1 wherein the processor is further operable to receive a request to save one or more of the identified search results, and operable to save the one or more search results to a memory of the computer.

5. The computerized system of claim 1 wherein the processor is further operable to receive a request to save a search string used in the search, and operable to save the search string to a memory of the computer.

6. The computerized system of claim 1 wherein the one or more data corpus comprises a data corpus uploaded by a user.

7. The computerized system of claim 1 wherein the one or more data corpus comprises a data corpus accessible by an internet connection.

8. The computerized system of claim 1 wherein the search results further comprises one or more documents uploaded to the system by a user.

9. The computerized system of claim 1 wherein the processor is further operable to recommend one or more of the search results using a programmed recommendation engine.

10. The computerized system of claim 1 wherein the presenting of the chart allows a selection of a centroid and wherein the processor is further programmable to assign a second plurality of coordinates to each of the search results based on the selected centroid.

11. A computerized system for generating a visualization of search results comprising:
a computer having at least one processor, wherein the at least one processor is operable to:
receive a user input of one or more search terms and a user selection of one or more data corpus via a computerized user interface to perform a search and gather search results;
display a three-dimensional chart on a display of the computer showing the gathered search results, wherein the chart showing the search results plotted based on the assigned plurality of coordinates for each of the search results based on an analyzed relatedness, wherein each of the search results on the plot is positioned based on a plurality of coordinates, wherein coordinates of greater magnitude have less relatedness and coordinates of magnitude closer to zero have more relatedness, such that related search results are close to each other on at least one axis, and unrelated search results are farther from each other on at least one axis.

12. The computerized system of claim 11 wherein the display of the three dimensional chart allows the chart to be movable to view the plotted results from different views based on an input from the user interface.

13. The computerized system of claim 11 wherein one of the search results can be selected by an input from the user interface, and wherein additional information about the selected one of the search results is presented on a pane on the display adjacent to the presented chart.

14. The computerized system of claim 11 wherein the processor is further operable to receive a request to save one or more of the identified search results via the user interface.

15. The computerized system of claim 11 wherein the processor is further operable to receive a request to save a search string used in the search via the user interface.

16. The computerized system of claim 11 wherein the one or more data corpus comprises a data corpus uploaded by a user.

17. The computerized system of claim 11 wherein the one or more data corpus comprises a data corpus accessible by an internet connection.

18. The computerized system of claim 11 wherein the search results further comprises one or more documents uploaded to the system by a user.

19. The computerized system of claim 11 wherein the processor is further operable to display one or more of the search results using a programmed recommendation engine.

20. The computerized system of claim 11 wherein the display of the chart allows a selection of a centroid through the user interface and wherein the processor is operable to display a second updated three-dimensional chart.
